(19) United States
(12) Patent Application Publication
(10) Pub. No.: US 2015/0330513 A1
(43) Pub. Date: Nov. 19, 2015

(54) Low Flow Needle Valve

(71) Applicant: International Clean Energy Solutions, Ltd., Tampa, FL (US)

(72) Inventor: Marco Gravel, Irving, TX (US)

(21) Appl. No.: 14/277,799

(22) Filed: May 15, 2014

(51) Int. Cl. F16K 1/02; F16K 31/53; F16K 31/50; F16K 1/52

(52) U.S. Cl. CPC F16K 1/02; F16K 1/523; F16K 31/535; F16K 31/50

(57) ABSTRACT

The invention uses a novel valve construction particularly useful for low-flow applications that allows for the entire flow range over a single 360-degree turn element by the use of a conically shaped needle valve.

### A. TECHNICAL FIELD OF THE INVENTION

The invention pertains to needle valve construction for very low constant-speed flow.

### B. BACKGROUND OF THE INVENTION

Most fluid valves provide a degree of accuracy at a specifically determined pressure level, and operate with fluids operating at a pressure high enough that viscosity and surface tension have little impact on flow speed. However, as working fluid pressure decrease below one bar, the viscosity and surface tension of fluids impact flow speed control accuracy significantly more than higher pressures.

Specialized valves offer low flow accuracy, but they have the disadvantage of being very expensive, and they are difficult to mass produce. Moreover, needle valves typically lack precision, and typically require multiple rotations to open the valve to change the flow speed of the liquid. Presently, no needle valve is known to allow flow precision in a single 360-degree turn while working under low pressure conditions. Valves that open completely within one rotation tend to be those which work under high pressure.

The valve construction industry continuously seek ways to build valves that operate across its entire range of flow even while under very low fluid operating pressure, and using a single turn of the valve operating shaft that can change valve condition from completely closed to fully open.

### C. SUMMARY OF THE INVENTION

The invention incorporates a flow control valve and needle consisting of: a) a hollow housing, and b) a hollow needle mounted in the housing and several interchangeable rods which provide a catch or stop which limits the rotation of the needle so that the maximum speed of the liquid can be controlled by the rod at a constant speed even when the speed and gravity pressure are very low.

The advantage of this valve is the simplicity of its constituent parts, and the ease of changing the maximum throughput. The internal components are of low precision.

This valve provides a very low liquid flow with very low pressure. The liquid flow can be adjusted from closed to fully open by rotating the knob less than a full rotation.

The flow rate speed can also be adjusted by changing the cross-flow (limitator disc) switch that slides on the rod within the housing.

### D. BRIEF DESCRIPTION OF THE SEVERAL VIEWS OF THE DRAWING(S):

Exemplary embodiments of the low-flow valve are set forth in the figures as numbered below:

FIG. 1—Exploded orthogonal view of an embodiment of the disclosed low-flow valve.

FIG. 2A—Orthogonal view of the embodiment of FIG. 1.

FIG. 2B—Front view of the embodiment of FIG. 1.

FIG. 2C—Section view of the FIG. 1 embodiment, along section lines A-A, as shown in FIG. 2.

FIG. 3A—Orthogonal view of the Control Rod 11.

FIG. 3B—Side View of the Control Rod 11.

FIG. 3C—Front View of Control Rod 11.

FIG. 3D—Rear View of Control Rod 11.

FIG. 4—Limitator Disc 10.

FIG. 5A—PRIOR ART—Needle Nose Valve, Closed

FIG. 5B—PRIOR ART—Needle Nose Valve, Partially Opened

FIG. 5C—PRIOR ART—Needle Nose Valve, Fully Opened

FIG. 6A—Additional side section view of the invention, closed.

FIG. 6B—Additional side section view of the invention, partially open.

FIG. 6C—Additional side section view of the invention, open.

### E. DETAILED DESCRIPTION OF THE INVENTION

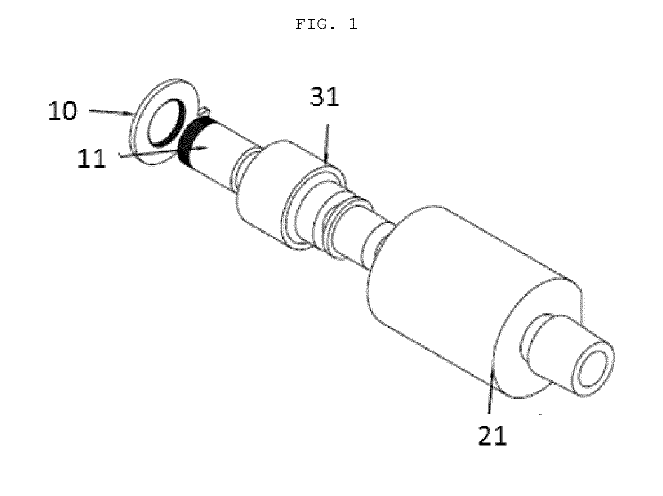

As shown in FIG. 1, the Valve Housing 21 is made of brass, stainless steel or other wear-resistant material. It is generally cylindrical in shape, having an aperture made up of several steps which help to form the specific operation of the valve.

The first step inside the Valve Housing 21 is the Housing Threads 1, used to establish the alignment of the Needle into the Housing 21. It also serves to create a mobile mechanical link which allows the Needle 31 to move into the Housing 21 and allows for adjustment of the fluid speed as it passes through the invention.

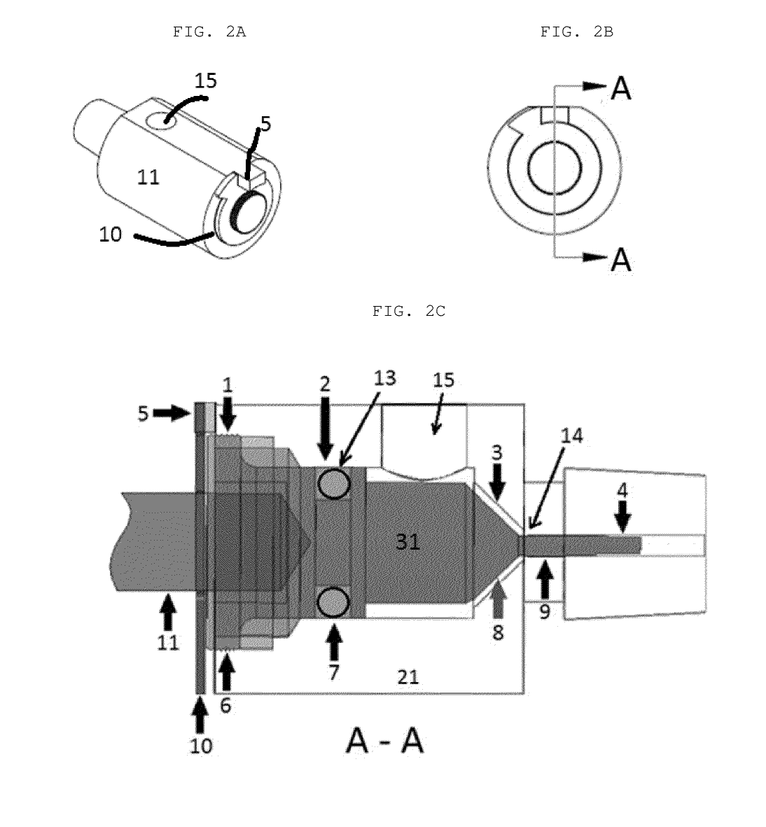

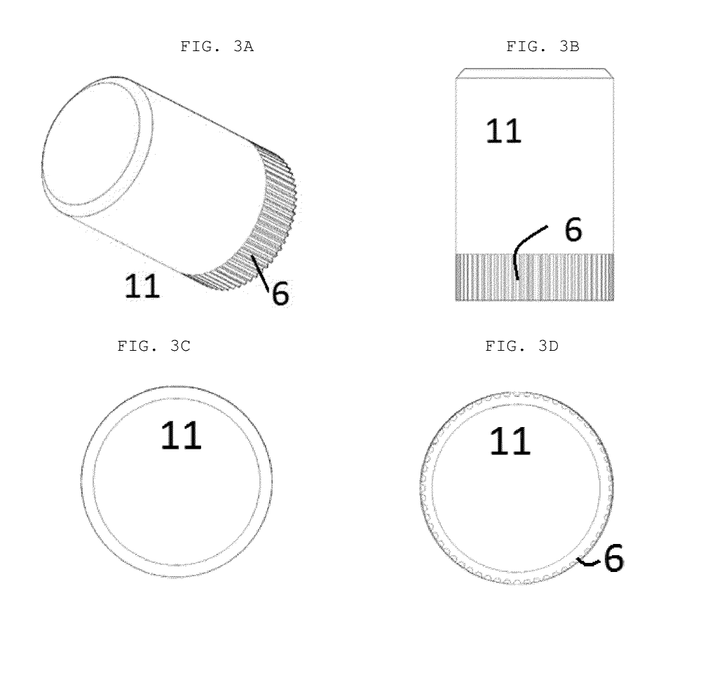

As shown in FIG. 2C, the second step of the Valve

Housing 21 is a smooth shiny flat O-Ring Surface 2 which prevents the wear of the O-Ring 13 and which creates a mechanical seal between the Housing 21 and the Needle 31. The O-Ring 13 prevents the escape of fluids between these parts.

The third step of the apparatus is a seal made by the Housing Conical Wall 3 and the Needle Conical Wall 8, which when brought together, creates a highly effective mechanical barrier to completely stop any flow through the Exit Port 4 when the needle is placed in the off position and the two walls meet. When the Needle 31 is placed in the on position and the two walls are held apart, however, the fluids flow.

The fourth step of the apparatus is the Exit Port 4. It is cylindrical and is used to adjust the flow of fluids during manipulation of the Needle 31 as it is placed in different “on” positions.

FIGS. 6A, 6B and 6C show how the regulation functions. The angle that unites the third and fourth steps forms creates the Regulating Surface 14. This is in the opening between the Needle Tip 9 and the interior wall of the Exit Port 4. The adjustment of the space between the Regulating Surface 14 and the Needle Tip 9 determines the size of the opening and the flow rate of fluid crossing the valve.

As shown in FIG. 21A, the Housing 21 also comprises a Block Detent 5 positioned directly at the first step of the

Housing 21. This Block Detent 5 is generally cube-shaped and serves as a stop when the Needle 31 is placed in the off position or as a maximum setting when the valve is rotated to be fully open.

The Needle 31 is made of brass, stainless steel, or other wear resistant material. It is moved within the Housing 21 by rotation. It is generally cylindrical in shape and is used in all four steps of the valve operation.

The first section of the Needle 31 is the Needle

Threads 6, which matches up with the Housing Threads 1.

Together, these threads serve as a mechanical connection between the Housing 21 and the Needle 31. The threads serve two important functions. The first is to establish the alignment of the Needle 31 into the Housing 21. The second is to move the Needle 31 inside the Housing 21. As the Needle 31 rotates in the threads, it moves in or out of the Housing 21.

The second section of the Needle is cylindrical in shape. It has a O-Ring Slot 7 to maintain the position of the O-Ring 13 which adheres against the Housing 21 to create a waterproof barrier that prevents the escape of fluids to the Exit Port 4.

The third section of the needle is tapered. As previously stated, the Housing Conical Wall 3 is constructed to match the Needle Conical Wall 8, and creates a mechanical barrier to seal the Invention, and block the passage of fluids when placed in the ‘off’ position.

The fourth section of the Needle 31 is conical in shape and is used to regulate the flow of fluids. It is angled to regulate the flow of fluids through the space created between the Regulating Surface 14 and the Needle Tip 9. A simple change in the angle of the Tip 9 allows to change the opening of the valve and flow without changing the threads.

Though the current embodiment uses an O-Ring 13 to Seal the invented valve, the O-Ring 13 is a convenience that is not necessary, though useful to have as a means of accommodating O-rings to create a mechanical sealant that prevents fluid from escaping from the moving parts of the valve.

The apparatus can be used for several types of fluids having different viscosities, the invention accepts fluids into its Intake 15, which flow is then governed by the user-set Regulating Surface 14, and then flows from the invented valve out from the device through the exit Port 4.

The apparatus is equipped with a Limitator Disc 10, which limits the rotation of the Control Rod 11 of the valve.

Shown in FIG. 4, the Limitator Disc 10 consists of a small disk which slides onto the Control Rod 11. The circular shape allows it to rotate freely against the Housing 11 inlet.

As shown FIG. 2A, 2B and 2C, the Housing 11 includes a Block Detent 5, a stop that limits the full rotation of Limitator Disc 10. The valve may be fitted with different flow selector and even different thread types to create different movements of the Needle 31 for a given amount of rotation. Each embodiment of the invented valve may contain different sizes of stops so as to increase or decrease the degree of rotation of the Needle 31 into the Housing 21 which changes the fluid flow speed.

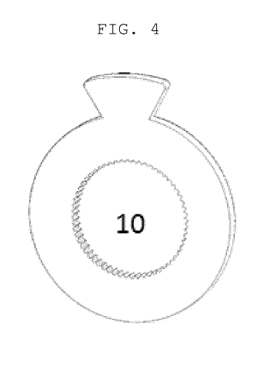

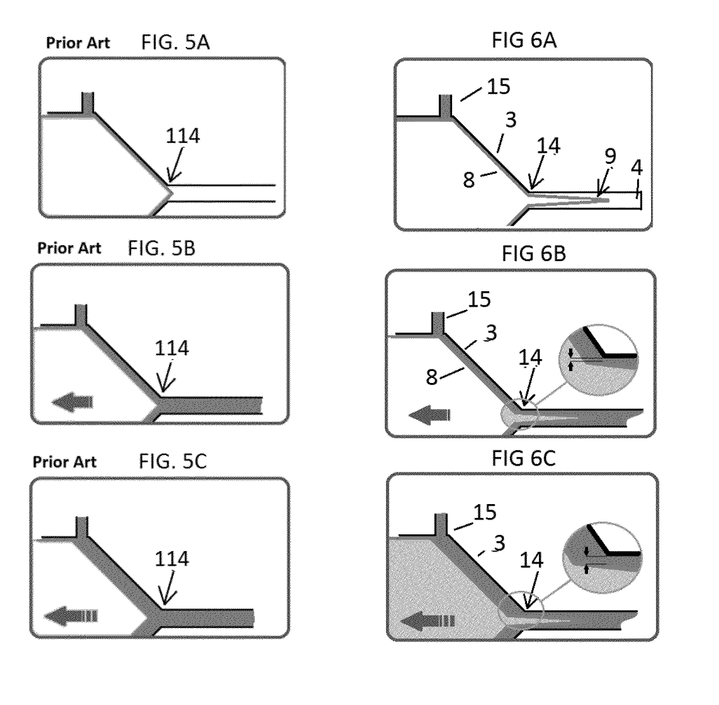

FIGS. 5 and 6 show a comparison between existing prior art (FIG. 5A, 5B, and 5C) and the invention at hand (FIGS. 6A, 6B, and 6C). The prior art has no needle element, but only a sudden Regulation Point 114, as shown in FIG. 5A, 5B and 5C. The valve tends to be open or closed, but little graduation between those two positions. Thus, the current industry products struggle to control regulation of flow. As FIG. 6B shows, however, the user can decide how much flow is desireable, and make decisions in real time to make changes in the valve disclosed herein, and then amend the flow rate with precision.

### DRAWING LEGEND

21 Housing
1 Housing Threading
2 O-Ring Flat Surface
3 Housing Conical Wall
4 Exit Port
5 bloc detent
31 Needle: 6 to 9
6 Threads
7 O-Ring Slot
8 Needle Conical Wall
9 Tip
10 Limitator disc
11 Control rod
13 O-Ring
14 Regulating Surface
15 Intake
114 Regulation Point

The inventor claims:

1. A needle Valve comprising:
a. a Valve Housing, into which all other elements are affixed;
b. an Intake Port, into which operating fluid is fed to the Valve;
c. an Exit Port, from which the flow of any operating fluid regulated by the Valve leaves the Valve Housing;
d. a tapered Needle, held so that its narrow end, the Needle Tip, extends into the flow of the fluid, and its wider end, the Connection End, is sufficient to partially and then fully block the flow of fluid as the Needle Tip is pushed to close the passage through which the fluid would otherwise flow;
e. Threads connecting the Needle within the Valve Housing so that a user can rotate the Needle in the threads to move the Needle Tip within the flow of fluid and thereby adjust the flow through the Exit Port;

[symbol]

2. A needle valve as in claim 1, further comprising:
a. a Control Rod with a Needle Connection End and a Drive End, constructed with the Needle Connection End connected to the Needle's Connection End, with a sprocket construction around the exterior of the Drive End;
b. a Limitator Disk which fits onto the Control Rod's Drive End, by which a User may turn the Disk and cause the Needle Tip to move through the flow and regulate flow through the Valve.
c. a Detent Block on the Housing prevents rotation of the Needle beyond a user-set limitation.

3. A needle valve as in claim 2, further comprising:
a. a Drive Sprocket constructed on the Drive End of the Control Rod;
b. a Limitator Disk Sprocket on the Limitator Disk with a sprocket construction matching the Drive Sprocket so that the Sprocket fits on the Control Rod's Drive End.
